(19) United States
(12) Patent Application Publication
(10) Pub. No.: US 2016/0369994 A1
(43) Pub. Date: Dec. 22, 2016

(54) Plant lamp convenient to disassemble, assemble and maintain

(71) Applicant: Zhifeng Liu, Ji'an City (CN)

(72) Inventor: Zhifeng Liu, Ji'an City (CN)

(21) Appl. No.: 15/164,700

(22) Filed: May 25, 2016

(30) Foreign Application Priority Data
Jun. 17, 2015 (CN) 201520418499.8

(51) Int. Cl. F21V 29/67; F21V 23/02; F21V 23/04; A01G 9/20; F21V 17/12; F21V 29/89; A01G 7/04; F21V 29/76; F21V 3/02

(52) U.S. Cl. CPC F21V 29/677; F21V 29/76; F21V 23/023; F21V 23/04; F21V 3/02; F21V 17/12; F21V 29/89; A01G 7/045; A01G 9/20; F21Y 2101/02

(57) ABSTRACT

Disclosed is a plant lamp convenient to disassemble, assemble and maintain, including a shell, a placement partition board installed in the shell, an LED lamp board connected with the placement partition board and a power supply, wherein the shell includes a surface cover, middle shell and bottom cover, connected by screws to form a closed installation cavity; a supporting rack is arranged on a bottom surface of the placement partition board; the placement partition board is placed on the bottom cover, the lower surface thereof is provided with the power supply, the top face thereof is provided with an aluminum cooling plate, and an LED lamp panel is connected to an upper surface of the aluminum cooling plate; and the power supply includes a plurality of independent closed storage batteries connected in parallel, and is connected with the placement partition board, and further with a power switch and socket.

### FIELD OF THE UTILITY MODEL

The present invention relates to the technical field of light emitting lamps, and in particular, to a plant lamp that promotes plant growth and is convenient to disassemble, assemble and maintain.

### BACKGROUND OF THE UTILITY MODEL

The sun light can promote the photosynthesis and is one of the physical environments necessary for the growth and development of plants, however, the sun light cannot irradiate the plants within twenty-four hours without interruption, resulting in reduced growth efficiency of the plants. An LED light source has the advantages of rich wavelength types, and the light radiated by the LED lamp can coincide with the spectral range necessary for the photosynthesis of the plants, so a variety of LED lamps can be combined according to needs to obtain monochromatic light or compound light. An LED plant lamp, just utilizing the functions of the above LED lamps to concentrate light with specific wavelengths to uniformly irradiate the plants, not only can regulate the flowering and fruiting of the plants, but also can control the plant heights and the nutrients of the plants, and thus the LED plant lamp is widely used in the fields of plant cultivation, facility horticulture and industrialized seedling production and the like. However, the problem of heat dissipation is not fully considered in the existing LED plant lamp, and since the plant lamp works for a long time at night, and the working period is long, the service life of the plant lamp is not optimistic. In addition, the power board of the existing LED plant lamp is fixed on a shell, thereby being difficult for disassembly and inconvenient for maintenance.

### SUMMARY OF THE UTILITY MODEL

To overcome the shortcomings in the prior art, the utility model provides a plant lamp, which is provided with a high power exhaust fan and is convenient to disassemble, assemble and maintain.

A technical solution adopted by the utility model is as follows: a plant lamp convenient to disassemble, assemble and maintain includes a shell, a placement partition board installed in the shell, an LED lamp board connected with the placement partition board and a power supply, wherein the shell includes a surface cover, a middle shell and a bottom cover, the surface cover and the bottom cover being connected to the middle shell by screws to form a closed installation cavity; a supporting rack is arranged on a bottom surface of the placement partition board, the placement partition board is placed on the bottom cover, the power supply is arranged on a lower surface of the placement partition board, an aluminum cooling plate is arranged on the top face of the placement partition board, and an LED lamp panel is connected to an upper surface of the aluminum cooling plate; and the power supply is composed of a plurality of independent closed storage batteries that are connected in parallel, and is connected with the placement partition board, and the power supply is further connected with a power switch and a socket.

The aluminum cooling plate is provided with a plurality of orderly arranged aluminum cooling fins.

Vent holes are formed in corresponding front and back surfaces of the middle shell, mesh enclosures are arranged on outer surfaces of the vent holes, and exhaust fans are arranged in the vent holes on the front surface.

A glass plate is arranged above the LED lamp panel, depression bars are arranged on four edges of the lower surface of the glass plate, and the depression bars are connected with the surface cover by screws to fix the glass plate on the surface cover The utility model has the beneficial effects that: by means of the implementation of the design solution, the storage batteries, the aluminum cooling plate and the LED lamp panel connected with the placement partition board in the shell of the plant lamp are independently placed in the shell, when disassembly or maintenance of the equipment is needed, the device therein can be taken out just by opening the bottom cover, thereby being very convenient; and in addition, the aluminum cooling plate is arranged between the placement partition board and the LED lamp panel to transfer heat by the both surfaces of the aluminum cooling plate, so that the heat conductance ability of the aluminum cooling plate is given full play, meanwhile, the exhaust fan is arranged, and provided with vent holes on the corresponding surface to realize an effect of internal and external air circulating cooling.

### BRIEF DESCRIPTION OF THE DRAWINGS

FIG. 1 is an exploded view of an overall structure of the utility model.

FIG. 2 is a schematic diagram of a structure of a placement partition board of the utility model.

FIG. 3 is a schematic diagram of a structure of an aluminum cooling plate of the utility model.

### DETAILED DESCRIPTION OF THE EMBODIMENTS

A further illustration of the utility model will be given below in combination with the accompany drawings and specific embodiments.

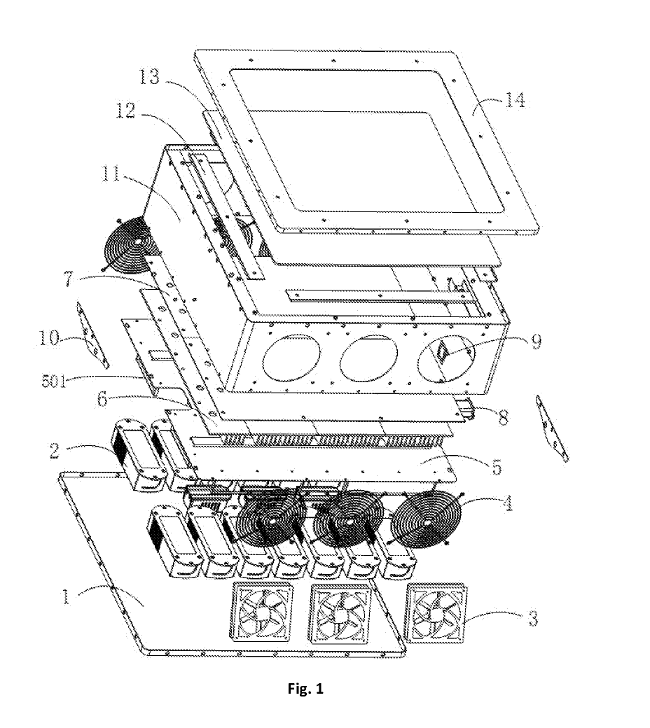

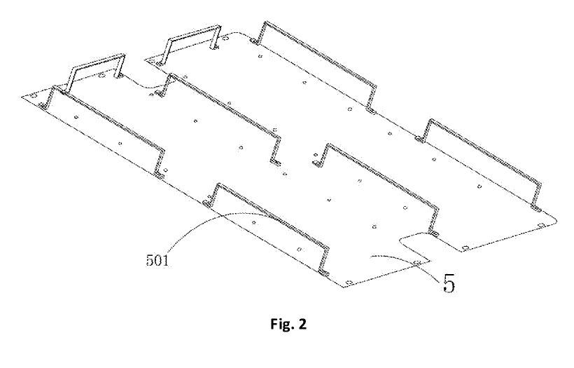

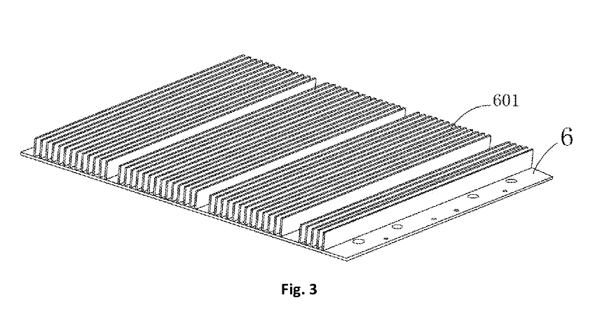

Refer to FIGS. 1, 2 and 3, a plant lamp convenient to disassemble, assemble and maintain includes a shell, a placement partition board 5 installed in the shell, an LED lamp board 7 connected with the placement partition board 5 and a power supply 2, wherein the shell includes a surface cover 14, a middle shell 11 and a bottom cover 1, the surface cover 14 and the bottom cover 1 being connected to the middle shell 11 by screws to form a closed installation cavity; a supporting rack 501 is arranged on a bottom surface of the placement partition board 5, the placement partition board 5 is placed on the bottom cover 1, the power supply 2 is arranged on a lower surface of the placement partition board 5, an aluminum cooling plate 6 is arranged on the top face of the placement partition board 5, and an LED lamp panel 7 is connected to an upper surface of the aluminum cooling plate 6. The power supply 2 is composed of a plurality of independent closed storage batteries that are connected in parallel, and is connected with the placement partition board 5, and the power supply 2 is further connected with a power switch 9 and a socket 8.

A glass plate 13 is arranged above the LED lamp panel 7, depression bars 12 are arranged on four edges of the lower surface of the glass plate 13, and the depression bars 12 are connected with the surface cover 14 through screws to fix the glass plate 13 on the surface cover 14.

The aluminum cooling plate 6 is provided with a plurality of orderly arranged aluminum cooling fins 601, the aluminum cooling plate 6 is arranged between the placement partition board 5 and the LED lamp panel 7 to transfer heat by the both surfaces of the aluminum cooling plate 6, so the heat conductance ability of the aluminum cooling plate 6 is given full play.

Vent holes are formed in corresponding front and back surfaces of the middle shell 11, mesh enclosures 4 are arranged on outer surfaces of the vent holes, exhaust fans 3 are arranged in the vent holes on the front surface, and are provided with vent holes on the corresponding surface to realize an effect of internal and external air circulating cooling.

The above embodiments of the utility model are merely examples used for clearly illustrating the utility model, rather than limitations to the embodiments of the utility model. Apparent changes or variations derived from the substantial spirit of the utility model still belong to the protection scope of the utility model.

1. A plant lamp convenient to disassemble, assemble and maintain, comprising a shell, a placement partition board (5) installed in the shell, an LED lamp board (7) connected with the placement partition board (5) and a power supply (2), wherein:
the shell comprises a surface cover (14), a middle shell (11) and a bottom cover (1), the surface cover (14) and the bottom cover (1) being connected to the middle shell (11) by screws to form a closed installation cavity; and
a supporting rack (501) is arranged on a bottom surface of the placement partition board (5), the placement partition board (5) is placed on the bottom cover (1), the power supply (2) is arranged on a lower surface of the placement partition board (5), an aluminum cooling plate (6) is arranged on the top face of the placement partition board (5), and an LED lamp panel (7) is connected to an upper surface of the aluminum cooling plate (6).

2. The plant lamp convenient to disassemble, assemble and maintain of claim 1, wherein the aluminum cooling plate (6) is provided with a plurality of orderly arranged aluminum cooling fins (601).

3. The plant lamp convenient to disassemble, assemble and maintain of claim 1, wherein vent holes are formed in corresponding front and back surfaces of the middle shell (11), mesh enclosures (4) are arranged on outer surfaces of the vent holes, and exhaust fans (3) are arranged in the vent holes on the front surface.

4. The plant lamp convenient to disassemble, assemble and maintain of claim 1, wherein the power supply (2) is composed of a plurality of independent closed storage batteries that are connected in parallel, and is fixedly connected with the placement partition board (5), and the power supply (2) is further connected with a power switch (9) and a socket (8).

5. The plant lamp convenient to disassemble, assemble and maintain of claim 1, wherein a glass plate (13) is arranged above the LED lamp panel (7), depression bars (12) are arranged on four edges of the lower surface of the glass plate (13), and the depression bars (12) are connected with the surface cover (14) by screws to fix the glass plate (13) on the surface cover (14).
